(19) United States
(12) Patent Application Publication
(10) Pub. No.: US 2024/0127162 A1
(43) Pub. Date: Apr. 18, 2024

(54) DATA MODEL DRIVEN IMPACT ANALYSIS OF LOGISTIC EXCEPTIONS

(71) Applicant: SAP SE, Walldorf (DE)

(72) Inventors: Jing GU, Shanghai (CN); Kai Mi, Shanghai (CN); Fei Wang, Shanghai (CN); Yiqun Hu, Shanghai (CN)

(21) Appl. No.: 18/046,240

(22) Filed: Oct. 13, 2022

(51) Int. Cl. G06Q 10/08; G06Q 10/06

(52) U.S. Cl. CPC G06Q 10/0833; G06Q 10/067

(57) ABSTRACT

A method may include detecting an occurrence of a logistic exception during a fulfilment cycle of an order. An impact of the logistic exception may be determined based on a tracking model having a plurality of interconnected tracking objects. The plurality of interconnected tracking objects may include a first tracking object corresponding to the order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order. One or more of the plurality of interconnected tracking objects may be updated based at least on the impact of the logistic exception. Related systems and computer program products are also provided.

### TECHNICAL FIELD

The subject matter described herein relates generally to database processing and more specifically to data model driven impact analysis of logistic exceptions.

### BACKGROUND

An enterprise may rely on a suite of enterprise software applications for sourcing, procurement, supply chain management, invoicing, and payment. The operations of the enterprise may also give rise to a variety of electronic documents including, for example, purchase orders, sales contracts, licensing agreements, and/or the like. As such, the enterprise software applications may integrate various electronic document management features. For example, an electronic document may include structured data, which may be stored in a data repository such as a relational database, a graph database, an in-memory database, a non-SQL (NoSQL) database, a key-value store, a document store, and/or the like. The enterprise software applications may manage an electronic document throughout its lifecycle, including creation, compliance, execution, and archiving.

### SUMMARY

Systems, methods, and articles of manufacture, including computer program products, are provided for data model driven impact analysis of logistic exceptions. In some example embodiments, there is provided a system that includes at least one processor and at least one memory. The at least one memory may include program code that provides operations when executed by the at least one processor. The operations may include: generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order; detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event; determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected tracking objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception associated with the first delivery order impacts the transport event; and updating, based at least on the impact of the logistic exception, one or more of the plurality of interconnected tracking objects comprising the tracking model.

In another aspect, there is provided a method for data model driven impact analysis of logistic exceptions. The method may include: generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order; detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event; determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected tracking objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception associated with the first delivery order impacts the transport event; and updating, based at least on the impact of the logistic exception, one or more of the plurality of interconnected tracking objects comprising the tracking model.

In another aspect, there is provided a computer program product including a non-transitory computer readable medium storing instructions. The instructions may cause operations may executed by at least one data processor. The operations may include: generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order; detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event; determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected tracking objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception associated with the first delivery order impacts the transport event; and updating, based at least on the impact of the logistic exception, one or more of the plurality of interconnected tracking objects comprising the tracking model.

In some variations of the methods, systems, and non-transitory computer readable media, one or more of the following features can optionally be included in any feasible combination.

In some variations, in response to determining that the logistic exception impacts the transport event, each of the first tracking object corresponding to the order, the second tracking object corresponding to the order item included in the order, the third tracking object corresponding to the delivery order item corresponding to the order item, the fourth tracking object corresponding to the first delivery order including the delivery order item, and the fifth tracking object corresponding to a transport event including the delivery order may be updated based at least on the logistic exception.

In some variations, the transport event may be a multistage transport event including a plurality of delivery orders. The determining of the impact of the logistic exception associated with the first delivery order may include determining whether the delay event associated with the first delivery order impacts one or more other delivery orders included in the plurality of delivery orders. The delay event may be propagated to one or more tracking objects representative of the one or more other delivery orders upon determining that the delay event impacts the one or more other delivery orders.

In some variations, whether the logistic exception associated with the first delivery order impacts a second delivery order included in the transport event may be determined. The second delivery order may trigger an update event in a location of the delivery order item from the intermediate location to a next location. In response to determining that the logistic exception impacts the transport event, a sixth tracking object corresponding to the second delivery order may be updated based at least on the logistic exception.

In some variations, in response to determining that the logistic exception associated with the first delivery order impacts the transport event, the value of the one or more data fields included in the fifth tracking object representative of the transport event may be updated based at least on the logistic exception.

In some variations, the updating of the one or more of the plurality of interconnected tracking objects may include updating a value of one or more data fields included in each of the one or more interconnected tracking objects.

In some variations, the updating of the one or more of the plurality of interconnected tracking objects may include updating a status and/or an estimated arrival time associated with the one or more of the plurality of interconnected tracking objects.

In some variations, a user interface providing a visual indication of the impact of the logistic exception may be generated for display at a client device.

In some variations, the user interface may include a plurality of interconnected nodes corresponding to the plurality of interconnected tracking objects. The visual indication may include rendering a first node representative of an impacted tracking object in a first color and a second node representative of a non-impacted tracking object in a second color.

In some variations, the visual indication may further include rendering a first directed edge from the first node to the second node in the second color and a second directed edge from the first node to a third node representative of another impacted tracking object in the first color.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of an enterprise software system, in accordance with some example embodiments;

FIG. 2 depicts a schematic diagram illustrating an example of an outbound scenario, in accordance with some example embodiments;

FIG. 3A depicts a block diagram illustrating an example of a tracking model, in accordance with some example embodiments;

FIG. 3B depicts a schematic diagram illustrating an example of a tracking object, in accordance with some example embodiments;

FIG. 3C depicts a block diagram illustrating an example of information propagation within a tracking model, in accordance with some example embodiments;

FIG. 4 depicts a screen shot illustrating an example of a user interface for impact analysis, in accordance with some example embodiments;

FIG. 5 depicts a flowchart illustrating an example of a process for data model driven impact analysis of logistic exceptions, in accordance with some example embodiments; and

FIG. 6 depicts a block diagram illustrating an example of a computing system, in accordance with some example embodiments; and

When practical, similar reference numbers denote similar structures, features, or elements.

### DETAILED DESCRIPTION

Enterprise software applications may provide a variety of procurement and supply chain management solutions while integrating document management features for the electronic documents (e.g., purchase orders, sales contracts, licensing agreements, and/or the like) that may arise as a part of the process. However, conventional enterprise solutions lack sufficient transparency for every stakeholder participating in a transaction. For example, an order, such as a purchase order or a sales order between a purchaser and a supplier, may include one or more items. The fulfilment cycle of at least some of the items in the order may entail a multistage transport event in which a delivery containing the items travels to one or more intermediate locations before reaching a final destination. A logistic exception, such as a delay, that occurs during one stage of a multistage transport event may or may not have an impact on the overall timeline of the transport event. Moreover, a delay to the transport event of one item within an order may not have any impact on the transport event of other items in the same order. However, conventional enterprise procurement solutions lack a mechanism to track the impact of logistic exceptions that occur during a multistage transport event. Moreover, in the event a supplier encounters a logistic exception during one stage of a multistage transport event and that logistic exception causes a corresponding delay to the transport event as a whole, that information is siloed with the supplier and not propagated to the purchaser.

In some example embodiments, a tracking engine may track the fulfilment cycle of each item in an order based on a corresponding tracking model including one or more interconnected tracking objects in a database. For example, the order may be a purchase order that undergoes an inbound procurement process or a sales order that undergoes an outbound sales process. As used herein, the term “tracking object” may refer to a data structure (e.g., a table) or an entry (e.g., a row or a record) within the data structure holding data values or references to other tracking objects. For example, a first tracking object representative of an order may be associated with a second tracking object representative of one item of the items included in the order. Meanwhile, the second tracking object associated with the item may be associated with a third tracking object representative of a corresponding delivery order item. Tracking objects representative of one or more delivery order items, including the aforementioned third tracking object, may be linked to a fourth tracking object corresponding to a delivery order containing the delivery order items. The fourth tracking object may be further linked to a fifth tracking object representative of the transport event containing the corresponding delivery order. It should be appreciated that the transport event may contain multiple delivery orders, each of which corresponding to a stage of the transport event where the item is traveling to an intermediate location or its final destination. Accordingly, the fifth tracking object representative of the transport event may be associated with multiple tracking objects, such as the fourth tracking object, each of which being representative of a single delivery order. The tracking engine may track the fulfilment cycle for each item in the order by at least accessing the first tracking object corresponding to the order, the second tracking object corresponding to the item, the third tracking object corresponding to the delivery order item, the fourth tracking object corresponding to the delivery order, and/or the fifth tracking object corresponding to the transport event.

In some example embodiments, the tracking engine may perform an impact analysis in the event of a logistic exception associated with the order. In some cases, the tracking engine may perform the impact analysis by at least traversing the tracking model associated with the order. The interconnected tracking objects included in the tracking model may articulate the relationship between the order and the corresponding order items, delivery order items, delivery orders, and transport events. Accordingly, the tracking engine may perform the impact analysis by at least traversing the tracking model and inspecting one or more of the interconnected tracking objects included in the tracking model. For example, the tracking engine may detect a delay of a delivery order associated with the order and perform the impact analysis in order to determine whether the delay of the delivery order impacts the timeliness of one or more subsequent delivery orders and/or the transport event associated with the delivery order. In the event the delay of the delivery order is determined to delay a subsequent delivery order and/or the entire transport event, the impact analysis performed by the tracking engine may further include identifying and updating the delivery order items, the order items, and the order impacted by the delay. For instance, the tracking engine may identify the third tracking object of the delivery order item that is associated with the fourth tracking object of the delayed delivery order causing the delay of the entire transport event. Moreover, the tracking engine may identify the second tracking object of the order item corresponding to the delivery order item associated with the third tracking object. The tracking engine may then propagate the information associated with the delayed transport event by at least updating one or more data fields (e.g., delivery status, expected delivery time, and/or the like) of the second tracking object associated with the order item.

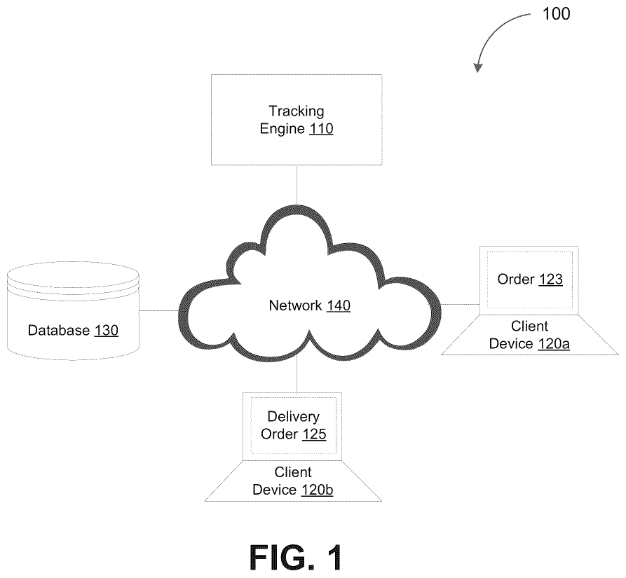

FIG. 1 depicts a system diagram illustrating an example of an enterprise software system 100, in accordance with some example embodiments. Referring to FIG. 1, the enterprise software system 100 may include a tracking engine 110 including a tracking engine 110, one or more client devices 120, and a database 130. The tracking engine 110, the one or more client devices 120, and the database 130 may be communicatively coupled via a network 140. The one or more client devices 120 may be a processor-based device including, for example, a smartphone, a tablet computer, a wearable apparatus, a virtual assistant, an Internet-of-Things (IoT) appliance, and/or the like. The database 130 may be a database including, for example, a relational database, a non-structured query language (NoSQL) database, an in-memory database, a graph database, a key-value store, a document store, and/or the like. The network 140 may be any wired network and/or a wireless network including, for example, a wide area network (WAN), a local area network (LAN), a virtual local area network (VLAN), a public land mobile network (PLMN), the Internet, and/or the like.

Referring again to FIG. 1, the tracking engine 110 may track the fulfilment cycle of each item in an order 123 (e.g., a purchase order, a sales order, and/or the like) between a purchaser and a supplier. As shown in FIG. 1, the order 123 may be generated at a first client device 120a associated with the purchaser. Moreover, the order 123 may include one or more items, each of which being shipped in a corresponding delivery order 125 generated at a second client device 120b associated with the supplier. An item in the order 125 may be delivered in one or multiple transport events, each of which having at least one stage of delivery corresponding to a delivery order. A multistage transport event in this context may thus refer to a transport event that is associated with multiple delivery orders, each of which corresponding one stage of delivery. During each stage of the multistage transport event, the item may be traveling to an intermediate location or its final destination. A logistic exception, such as a delay, associated with one stage of the multistage transport event may or may not impact the timeliness of subsequent stages of the transport event. Thus, in some example embodiments, the tracking engine 110 may track the fulfilment cycle of each item in the order 123 including by determining whether the overall timeliness of any multistage transport event included in the order 123 is impacted by a delay during one or more constituent stages.

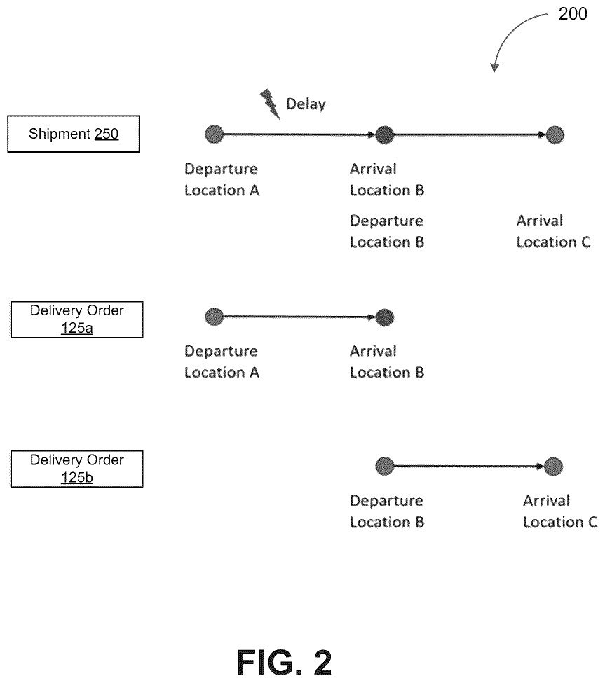

To further illustrate, FIG. 2 depicts a schematic diagram illustrating an example of an outbound scenario 200 in which a logistic exception (e.g., a delay) occurs during one stage of a multistage transport event 250. As shown in FIG. 2, the multistage transport event 250 may include a first stage associated with a first delivery order 125a in which an item from the order 123 is moved from a starting location (e.g., Location A) to an intermediate location (e.g., Location B) and a second stage associated with a second delivery order 125b in which the item is moved from the intermediate location (e.g., Location B) to a next location, which in this case is its final destination (e.g., Location C).

In the example show in FIG. 2, a logistic exception (e.g., a delay) occurs during the first stage of the transport event 250. However, that delay may or may not have an impact on the second stage of the transport event 250. For example, although the first delivery order 125a may arrive late at the intermediate location (e.g., Location B), the second delivery order 125b may still arrive at the final destination (e.g., Location C) on time if the second delivery order 125b is still able to depart the intermediate location (e.g., Location B) on time or spends less than in transit than expected. Accordingly, in some example embodiments, the tracking engine 110 may perform an impact analysis to determine whether the logistic exception (e.g., delay) associated with the first delivery order 125a impacts the timeliness of the transport event 250 as a whole. As described in further details below, if the tracking engine 110 determines that the logistic exception (e.g., delay) associated with the first delivery order 125a does impact the timeliness of the second delivery order 125b and/or the transport event 250 as a whole, the tracking engine 110 may be then propagate this delay event to one or more corresponding tracking objects in order to update the purchaser associated with the order 123.

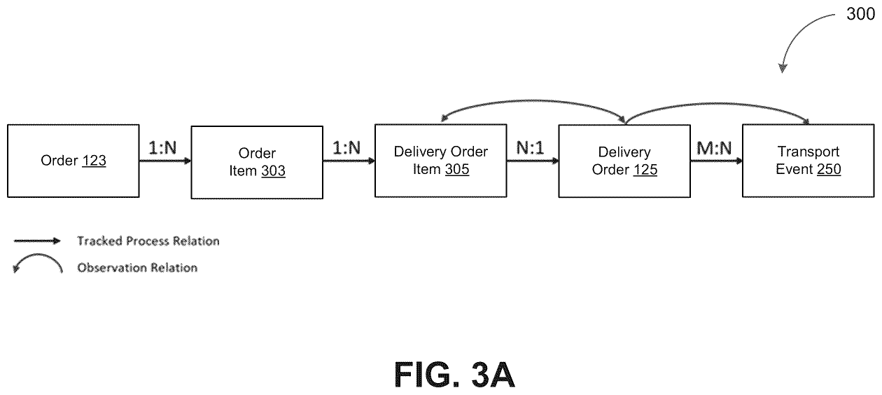

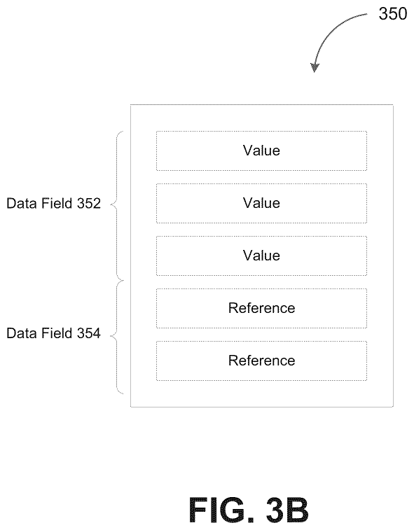

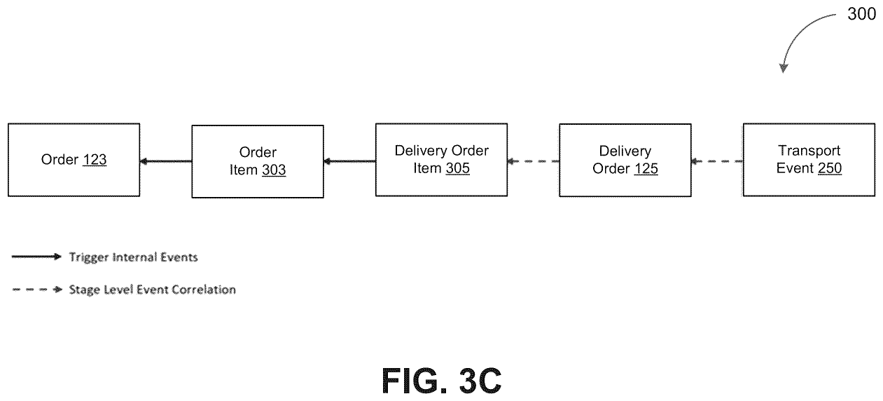

FIG. 3A depicts a block diagram illustrating an example of a tracking model 300, in accordance with some example embodiments. In some example embodiments, the tracking model 300 may articulate a mapping between the tracking objects associated with the fulfilment lifecycle of various item included in the order 123. The tracking engine 110 may therefore use the tracking model 300 to perform an impact analysis and determine, for example, whether a logistic exception during one stage of the multistage transport event 250 impacts the overall timeliness of the transport event 250. Moreover, the tracking engine 110 may use the tracking model 300 in order to propagate a delay event to the relevant tracking objects.

As shown in FIG. 3A, in response to the generation of the order 123 at the first client device 120a, the tracking engine 10 may generate and maintain a first tracking object corresponding to the order 123 at the database 130. Moreover, a second tracking object corresponding to each of an N quantity of order items 303 included in the order 123 may also be generated and maintained at the database 130. As noted, one or more order items 303 may map to a single delivery order. This relationship is shown in FIG. 3A where an N quantity of delivery order items 305, each of which corresponding to one of the order items 303, may map to the delivery order 125. Moreover, FIG. 3A shows that an M quantity of the delivery orders 125 may map to an N quantity of the transport events 250. Accordingly, when the delivery order 125 including the N quantity of delivery order items 305 is generated at the second client device 120b, a third tracking object corresponding to the delivery order 125, a fourth tracking object corresponding to each of the delivery order items 305, and a fifth tracking object corresponding to each of the transport events 250 may be generated and maintained at the database 130. The fourth tracking object corresponding to the delivery order item 305 may be linked to the second tracking object associated with the corresponding order item 303. Furthermore, the fourth tracking object corresponding to the delivery order item 305 may be linked to the third tracking object associated with the corresponding delivery order 125, which may be in turned linked to the fifth tracking object corresponding to the transport event 250.

FIG. 3B depicts a schematic diagram illustrating an example of a tracking object 350, in accordance with some example embodiments. In some example embodiments, the tracking object 350 may implement one or more of the first tracking object corresponding to the order 123, the second data corresponding to each of an N quantity of order items 303 included in the order 123, the third tracking object corresponding to the delivery order 125, the fourth tracking object corresponding to each of the delivery order items 305, and the fifth tracking object corresponding to each of the transport events 250. In some cases, the tracking object 350 may be a data structure (e.g., a table) or an entry (e.g., a row or a record) within the data structure holding data values and/or references to other tracking objects. Accordingly, in the example shown in FIG. 3B, the tracking object 350 may include one or more data fields 352 occupied by values indicating, for instance, an identifier, a description, a type, a status, a location, an expected delivery time, and/or the like. Furthermore, in the example shown in FIG. 3B, the tracking object 350 may include one or more data fields 354 occupied by references to other tracking objects. For example, where the tracking object 350 corresponds to the delivery order item 305, the one or more data fields 354 may include an identifier of the corresponding order item 303, an identifier of the order 123 containing the order item 303, an identifier of the delivery order 125 containing the delivery order item 305, and/or an identifier of the transport event 250 associated with the delivery order 125.

As noted, the tracking model 300 may be used by the tracking engine 110 in order to perform an impact analysis and determine, for example, whether a logistic exception during one stage of the multistage transport event 250 impacts the overall timeliness of the transport event 250. In the examples shown in FIGS. 2 and 3A, the tracking engine 110 may identify, based at least on the tracking model 300, the first delivery order 125a and the second delivery order 125b that form the transport event 250. Accordingly, the tracking engine 110 may determine, based at least on the tracking objects associated with each of the first delivery order 125a, the second delivery order 125b, and the transport event 250, whether the delay associated with the first delivery order 125a impacts the timeliness of the second delivery order 125b and the transport event 250. For example, where the data values associated with these tracking objects indicate that the second delivery order 125b may still arrive at the final destination (e.g., Location C) on time if the second delivery order 125b is still able to depart the intermediate location (e.g., Location B) on time or spends less than in transit than expected, the tracking engine 110 may determine, at least temporarily, that the delay of the first delivery order 125a does not impact the timeliness of the second delivery order 125 and the transport event 250 as a whole. Contrastingly, where the first delivery order 125a arrived at the intermediate location (e.g., Location B) after the departure time of the second delivery order 125a and the second delivery order 125a cannot arrive at the final destination (e.g., Location C) on time even with a minimum transit time, the tracking engine 110 may determine that the delay of the first delivery order 125a does impact the timeliness of the second delivery order 125b and/or that of the transport event 250 as a whole.

In the event the tracking engine 110 determines that the logistic exception (e.g., delay) associated with the first delivery order 125a does impact the timeliness of the second delivery order 125b and/or the transport event 250 as a whole, the tracking engine 110 may propagate this delay event to one or more relevant tracking objects indicated by the tracking model 300. For example, FIG. 3C shows that delay event may be propagated to the tracking objects corresponding to the second delivery order 125b and the transport event 250 as well as the tracking objects representative of the corresponding delivery order items 305, order items 303, and the order 123 itself. In some cases, the propagation of the delay event may include the tracking engine 110 accessing the relevant tracking objects to update the values of one or more relevant data fields. For instance, the delivery status and expected delivery time may be propagated to the tracking objects corresponding to the delivery order items 305. In the case of the order 123, the propagation of the delay event may include accessing the tracking objects of the order items 303 affected by the logistic exception while those not affected by the logistic exception are left unaltered. Accordingly, in the example shown in FIGS. 3A-B, the tracking engine 110 may access the second tracking object associated with the impacted order item 303 to update, for example, the delivery status and expected delivery time of the order item 303.

In some cases, in addition to having multiple stages corresponding to the first delivery order 125a and the second delivery order 125b, the transport event 250 may include one or more freight units, each of which containing one or more of the delivery order items 305. Accordingly, the tracking of the fulfilment cycle and the impact analysis triggered by a logistic exception (e.g., delay) may include identifying, for example, based on the tracking 300, the one or more freight units impacted by the logistic exception. For instance, in the example shown in FIGS. 2 and 3A-B, the transport event 250 may include multiple freight units, which are moved as a part of the first delivery order 125a from the starting location (e.g., Location A) to the intermediate location (e.g., Location B) before being moved as a part of the second delivery order 125b from the intermediate location (e.g., Location B) to the final destination (e.g., Location C). Accordingly, the tracking engine 110 may further generate and maintain, at the database 300, one or more tracking objects corresponding to the freight units. Those tracking objects may be linked to tracking objects representative of the first delivery order 125a, the second delivery order 125b, the transport event 250, and the constituent delivery order items 305.

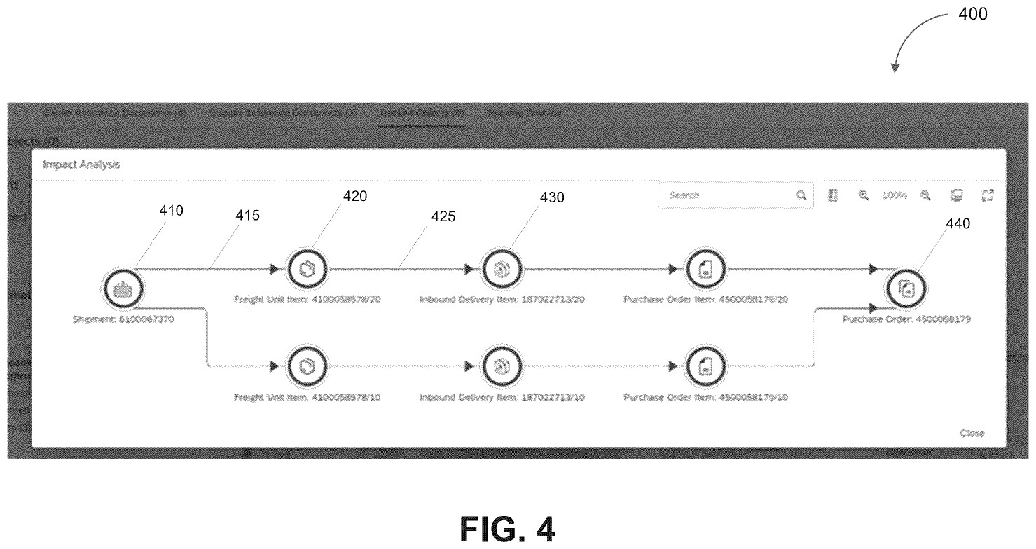

In some example embodiments, the tracking engine 110 may perform the impact analysis automatically, for example, upon detecting one or more logistic exceptions. Alternatively and/or additionally, the tracking engine 110 may perform the impact analysis on demand, for example, in response to one or more commands received from the first client device 120a and/or the second client device 120b. FIG. 4 depicts a screenshot illustrating an example of a user interface 400 for impact analysis, in accordance with some example embodiments. In some cases, the tracking engine 110 may generate the user interface 400 to display, for example, at the first client device 120a and/or the second client device 120b, the results of the impact analysis performed by the tracking engine 110. In the example shown in FIG. 4, the results of the impact analysis performed by the tracking engine 110 may include the various transport events, freight units, delivery orders, delivery order items, order items, and/or orders impacted by a logistic exception. The transport events, freight units, delivery orders, delivery order items, order items, and/or orders impacted by the logistic exception may be identified based on, for example, the tracking model 300.

In an inbound or outbound delivery scenario where the transport event 250 includes one or more delivery orders but not freight units, the tracking engine 110 may identify the one or more delivery order items 305 impacted by a logistic exception (e.g., a delay event) by inspecting one or more of the tracking objects including in the tracking model 300 to identify a match in planned events between the one or more delivery order items 305 and the transport event 250. For example, the first delivery order 125a and the second delivery order 125b included in the transport event 250 may be first identified based on one or more matching values included in the tracking object associated with each of the first delivery order 125a, the second delivery order 125b, and the transport event 250. Examples of such values may include matching identifiers (e.g., eventMatchKey), locations (e.g., locationAltKey), and event types (e.g., eventType). The one or more delivery order items 305 included in the first delivery order 125a and/or the second delivery order 135b may then be identified by inspecting the tracking objects associated with the first delivery order 125a and/or the second delivery order 125b to identify, based on the data values and/or references contained therein, the tracking objects associated with the one or more delivery order items 305. Accordingly, the one or more delivery items 305 may be mapped to the first delivery order 125a and/or the second delivery order 125b of the transport event 250 by inspecting the corresponding tracking objects and identifying one or more matching values in the data fields included in the tracking objects. The tracking engine 110 may then identify the order items 303 associated with the delivery order items 305 based on a link between the corresponding tracking objects such as the tracking objects of the order items 303 including the identifier of the delivery order items 305 and/or the tracking object of the delivery order 305 including the identifiers of the order items 303. Furthermore, the tracking engine 110 may identify the order 123 associated with the one or more order items 305 based on the link between the corresponding tracking objects (e.g., the tracking objects of the order items 305 including an identifier of the order 123 and/or the tracking object of the order 125 including an identifier of the order items 305).

In an inbound or outbound delivery scenario where the transport event 250 includes freight units, the tracking engine 110 may identify the one or more freight units impacted by a logistic exception (e.g., a delay event) based on a match in planned events. For example, the tracking engine 110 may inspect one or more of the tracking objects included in the tracking model 300 to identify, based on the data values and/or references contained therein, the tracking objects of the freight units associated with the transport event 250. In some cases, the tracking objects of the freight units may be identified based on the tracking objects of the freight units having the matching planned events as the transport event 250. For instance, the one or more freight units may be mapped to the transport event 250 or the first delivery order 125a and/or the second delivery order 125b of the transport event 250 based on the corresponding tracking objects having the same values for eventMatchKey, locationAltKey, and eventType. The tracking engine 110 may further identify the delivery order items 305 included in each freight unit based on a link between the corresponding tracking objects such as, for example, the tracking object of the freight unit including one or more references to the delivery order items 305. Moreover, the tracking engine 110 may also identify the order items 303 associated with the delivery order items 305 based on a link between the corresponding tracking objects (e.g., the tracking objects of the order items 303 including the identifier of the delivery order items 305 and/or the tracking object of the delivery order 305 including the identifiers of the order items 303). Finally, the tracking engine 110 may identify the order 123 associated with the one or more order items 303 based on the link between the corresponding tracking objects (e.g., the tracking objects of the order items 305 including an identifier of the order 123 and/or the tracking object of the order 125 including an identifier of the order items 305).

Referring again to FIG. 4, the results of the impact analysis performed by the tracking engine 110 displayed in the user interface 400 may include one or more interconnected nodes. Each node may correspond to a transport event, a freight unit item, a delivery order item, an order item, and an order. A directed edge between two nodes may indicate a relationship between the two nodes. For example, a first directed edge 415 from a first node 410 corresponding to a transport event and a second node 420 corresponding to a freight unit item may indicate that the freight unit item is a part of the transport event while a second directed 425 edge from the second node 420 corresponding to the freight unit item may to a third node 430 corresponding to an delivery order item may indicate a correspondence between the freight unit item and the delivery order item.

In some example embodiments, the user interface 400 may include one or more visual indicators of the results impact analysis performed by the tracking engine 110. For example, if a logistic exception (e.g., delay) impacts the transport event then the first node 410 representative of the transport event may be displayed in a first color (and/or shape). Contrastingly, if the logistic exception (e.g., delay) does not ultimately impact the order, a fourth node 440 corresponding to the order may be displayed in a second color (and/or shape) that is different than the first color (and/or shape). In instances where a logistic exception impacts two successive nodes such as, for example, the first node 410 corresponding to the transport event and the second node 420 corresponding to the freight unit item, the first directed edge 415 between the two nodes may also be displayed in a different color than if the logistic exception impacting the transport event associated with the first node 410 does not impact the freight unit item associated with the second node 420.

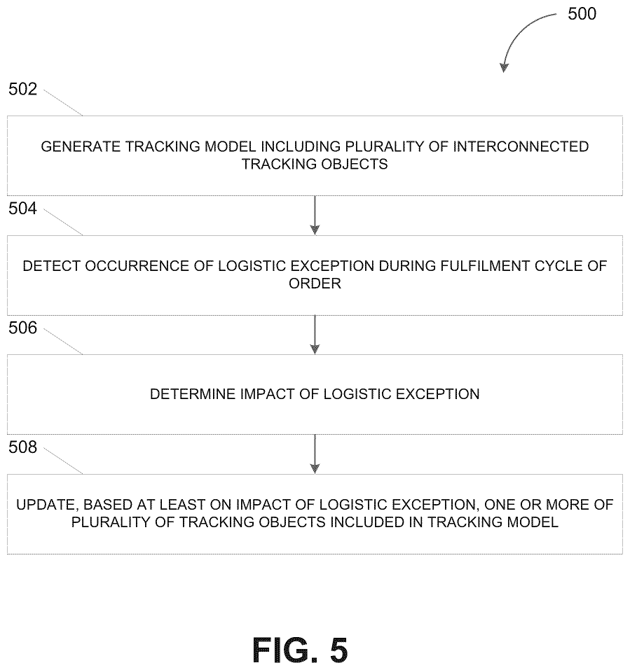

FIG. 5 depicts a flowchart illustrating an example of a process 500 for data model driven impact analysis of logistic exceptions, in accordance with some example embodiments. Referring to FIGS. 1-5, the process 500 may be performed by the tracking engine 110.

At 502, the tracking engine 110 may generate a tracking model including a plurality of interconnected tracking objects. In some example embodiments, the tracking engine 110 may generate and maintain, at the database 130, the tracking model 300 associated with the order 123. The tracking model 300 may include, for instance, the first tracking object corresponding to the order 123, the second tracking object corresponding to each of an N quantity of order items 303 included in the order 123, the third tracking object corresponding to the delivery order 125, the fourth tracking object corresponding to each of the delivery order items 305, and the fifth tracking object corresponding to each of the transport events 250.

At 504, the tracking engine 110 may detect an occurrence of a logistic exception during a fulfilment cycle of an order. In some example embodiments, the tracking engine 110 may detect a logistic exception based on one or more events that occur during the fulfilment cycle of the order 123. In some cases, the tracking engine 110 may detect the logistic exception based on an inspection of one or more of the interconnected tracking objects included in the tracking model 300. Moreover, in some cases, the tracking engine 110 may detect the logistic exception based on one or more of (i) a delay event associated with the first delivery order and/or the transport event, (ii) a time of an arrival event associated with the first delivery order and/or the transport event, and (iii) a failure to receive the arrival event associated with the first delivery order and/or the transport event.

To further illustrate, the tracking engine 110 may detect the logistic exception based on the occurrence of, for example, a delay event associated with the first delivery order 125a and/or the second delivery order 125b included in the transport event 250 associated with the order 123. Alternatively and/or additionally, the tracking engine 110 may detect the logistic exception based on a timing associated with an arrival event associated with the first delivery order 125a and/or the second delivery order 125b included in the transport event 250 associated with the order 123. For example, the tracking engine 110 may detect the logistic exception if the tracking engine 110 fails to detect the arrival event more than a threshold quantity of time past an expected arrival time for the first delivery order 125a and/or the second delivery order 125b included in the transport event 250 associated with the order 123. In some cases, the tracking engine 110 may detect the delay event and/or the arrival event in response to receiving, via an application programming interface (API), one or more corresponding data packets. The data packets associated with the delay event and/or the arrival event may originate from an event listener, a message queue, and/or the client device 120. Furthermore, the data packets associated with the delay event and/or the arrival event may include one or more data values including, for example, an expected arrival time, an arrival time, a status, and/or the like.

At 506, the tracking engine 110 may determine an impact of the logistic exception. In some example embodiments, the tracking engine 110 may perform an impact analysis to determine the impact of the logistic exception (e.g., delay). For example, in some cases, the tracking engine 110 may perform the impact analysis to determine, based at least on the tracking model 300, whether the delay of the first delivery order 125a impacts the timeliness of the second delivery order 125b and/or the transport event 250 as a whole. The impact analysis may include identifying, based at least on an identifier of the order 123 associated with the first delivery order 125a, the tracking model 300. Moreover, the impact analysis may include traversing the plurality of interconnected tracking objects included in the tracking model 300 to determine, based at least on an edge interconnecting tracking objects representative of the first delivery order 125a and the transport event 250, that the first delivery order 125a is a part of the transport event 250. Finally, the impact analysis may include determining, based at least on a value of one or more data fields included in the tracking object associated with the transport event 250, whether the delay event associated with the first delivery order 125a impacts the transport event 250 as a whole.

In some cases, the transport event 250 may be a multistage transport event including multiple delivery orders. Accordingly, in the examples shown in FIGS. 2 and 3A, the tracking engine 110 may determine, based at least on the tracking objects associated with each of the first delivery order 125a, the second delivery order 125b, and the transport event 250, whether the delay associated with the first delivery order 125a impacts the timeliness of the second delivery order 125b and the transport event 250. For example, where the data values associated with these tracking objects indicate that the second delivery order 125b may still arrive at the final destination (e.g., Location C) on time if the second delivery order 125b is still able to depart the intermediate location (e.g., Location B) on time or spends less than in transit than expected, the tracking engine 110 may determine, at least temporarily, that the delay of the first delivery order 125a does not impact the timeliness of the second delivery order 125 and the transport event 250 as a whole. Contrastingly, where the first delivery order 125a arrived at the intermediate location (e.g., Location B) after the departure time of the second delivery order 125a and the second delivery order 125a cannot arrive at the final destination (e.g., Location C) on time even with a minimum transit time, the tracking engine 110 may determine that the delay of the first delivery order 125a does impact the timeliness of the second delivery order 125b and/or that of the transport event 250 as a whole.

In the event the tracking engine 110 determines that the logistic exception (e.g., delay) associated with the first delivery order 125a does impact the timeliness of the second delivery order 125b and/or the transport event 250 as a whole, the tracking engine 110 may perform the impact analysis to identify the delivery order items 305, the order items 303, and the order 123 also impacted by the delay of the transport event 250. For instance, as shown in FIG. 3A, the order 123 may be associated with a first tracking object maintained at the database 130, which is linked to a tracking object associated with each of the order items 303 included in the order 123. Each of the tracking objects corresponding to the order items 303 may be linked to a tracking object associated with the corresponding delivery order items 305. Meanwhile, the tracking objects associated with each of the delivery order items 305 may be linked to the tracking objects corresponding to the first delivery order 125a and/or the second delivery order 125b. The tracking objects associated with the first delivery order 125a and the second delivery order 125b may be further linked to the tracking object corresponding to the transport event 250. The association between these tracking objects, which are articulated in the tracking model 300, for example, may be used to identify the delivery order items 305, the order items 303, and the order 123 also impacted by the delay of the transport event 250.

At 508, the tracking engine 110 may update, based at least on the impact of the logistic exception, one or more of the plurality of tracking objects included in the tracking model. In some example embodiments, the tracking engine 110 propagate the delay event associated with the transport event 250 to one or more relevant tracking objects indicated by the tracking model 300. For example, FIG. 3C shows that delay event may be propagated to the tracking objects corresponding to the second delivery order 125b and the transport event 250 as well as the tracking objects representative of the corresponding delivery order items 305, order items 303, and the order 123 itself. In some cases, the propagation of the delay event may include the tracking engine 110 accessing the relevant tracking objects to update the values of one or more relevant data fields (e.g., delivery status, expected delivery time, and/or the like). In the case of the order 123, the propagation of the delay event may include accessing the tracking objects of the order items 303 affected by the logistic exception while those not affected by the logistic exception are left unaltered. Accordingly, in the example shown in FIGS. 3A-B, the tracking engine 110 may access the second tracking object associated with the impacted order item 303 to update, for example, the delivery status and expected delivery time of the order item 303.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order; detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event; determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected tracking objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception associated with the first delivery order impacts the transport event; and updating, based at least on the impact of the logistic exception, one or more of the plurality of interconnected tracking objects comprising the tracking model.

Example 2: The system of Example 1, wherein the operations further comprise: in response to determining that the logistic exception impacts the transport event, updating, based at least on the logistic exception, each of the first tracking object corresponding to the order, the second tracking object corresponding to the order item included in the order, the third tracking object corresponding to the delivery order item corresponding to the order item, the fourth tracking object corresponding to the first delivery order including the delivery order item, and the fifth tracking object corresponding to a transport event including the delivery order.

Example 3: The system of any of Examples 1 to 2, wherein the transport event is a multistage transport event including a plurality of delivery orders, wherein the determining of the impact of the logistic exception associated with the first delivery order includes determining whether the delay event associated with the first delivery order impacts one or more other delivery orders included in the plurality of delivery orders, and wherein the delay event is propagated to one or more tracking objects representative of the one or more other delivery orders upon determining that the delay event impacts the one or more other delivery orders.

Example 4: The system of any of Examples 1 to 3, wherein the operations further comprise: determining whether the logistic exception associated with the first delivery order impacts a second delivery order included in the transport event, the second delivery order triggering an update event in a location of the delivery order item from the intermediate location to a next location; and in response to determining that the logistic exception impacts the transport event, updating, based at least on the logistic exception, a sixth tracking object corresponding to the second delivery order.

Example 5: The system of any of Examples 1 to 4, wherein the operations further include: in response to determining that the logistic exception associated with the first delivery order impacts the transport event, updating, based at least on the logistic exception, the value of the one or more data fields included in the fifth tracking object representative of the transport event.

Example 6: The system of any of Examples 1 to 5, wherein the updating of the one or more of the plurality of interconnected tracking objects includes updating a value of one or more data fields included in each of the one or more interconnected tracking objects.

Example 7: The system of any of Examples 1 to 6, wherein the updating of the one or more of the plurality of interconnected tracking objects includes updating a status and/or an estimated arrival time associated with the one or more of the plurality of interconnected tracking objects.

Example 8: The system of any of Examples 1 to 7, wherein the operations further comprise: generating, for display at a client device, a user interface providing a visual indication of the impact of the logistic exception.

Example 9: The system of Example 8, wherein the user interface includes a plurality of interconnected nodes corresponding to the plurality of interconnected tracking objects, and wherein the visual indication includes rendering a first node representative of an impacted tracking object in a first color and a second node representative of a non-impacted tracking object in a second color.

Example 10: The system of Example 9, wherein the visual indication further includes rendering a first directed edge from the first node to the second node in the second color and a second directed edge from the first node to a third node representative of another impacted tracking object in the first color.

Example 11: A computer-implemented method, comprising: generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order; detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event; determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected tracking objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception associated with the first delivery order impacts the transport event; and updating, based at least on the impact of the logistic exception, one or more of the plurality of interconnected tracking objects comprising the tracking model.

Example 12: The method of Example 11, further comprising: in response to determining that the logistic exception impacts the transport event, updating, based at least on the logistic exception, each of the first tracking object corresponding to the order, the second tracking object corresponding to the order item included in the order, the third tracking object corresponding to the delivery order item corresponding to the order item, the fourth tracking object corresponding to the first delivery order including the delivery order item, and the fifth tracking object corresponding to a transport event including the delivery order.

Example 13: The method of any of Examples 11 to 12, wherein the transport event is a multistage transport event including a plurality of delivery orders, wherein the determining of the impact of the logistic exception associated with the first delivery order includes determining whether the delay event associated with the first delivery order impacts one or more other delivery orders included in the plurality of delivery orders, and wherein the delay event is propagated to one or more tracking objects representative of the one or more other delivery orders upon determining that the delay event impacts the one or more other delivery orders.

Example 14: The system of any of Examples 11 to 13, further comprising: determining whether the logistic exception associated with the first delivery order impacts a second delivery order included in the transport event, the second delivery order triggering an update event in a location of the delivery order item from the intermediate location to a next location; and in response to determining that the logistic exception impacts the transport event, updating, based at least on the logistic exception, a sixth tracking object corresponding to the second delivery order.

Example 15: The method of any of Examples 11 to 14, wherein the updating of the one or more of the plurality of interconnected tracking objects includes updating a value of one or more data fields included in each of the one or more interconnected tracking objects.

Example 16: The method of any of Examples 11 to 15, wherein the updating of the one or more of the plurality of interconnected tracking objects includes updating a status and/or an estimated arrival time associated with the one or more of the plurality of interconnected tracking objects.

Example 17: The method of any of Examples 11 to 16, further comprising: generating, for display at a client device, a user interface providing a visual indication of the impact of the logistic exception.

Example 18: The method of Example 17, wherein the user interface includes a plurality of interconnected nodes corresponding to the plurality of interconnected tracking objects, and wherein the visual indication includes rendering a first node representative of an impacted tracking object in a first color and a second node representative of a non-impacted tracking object in a second color.

Example 19: The method of Example 18, wherein the visual indication further includes rendering a first directed edge from the first node to the second node in the second color and a second directed edge from the first node to a third node representative of another impacted tracking object in the first color.

Example 20: A non-transitory computer readable medium storing instructions, which when executed by at least one data processor, result in operations comprising: generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order; detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event; determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected tracking objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception as sociated with the first delivery order impacts the transport event; and updating, based at least on the impact of the logistic exception, one or more of the plurality of interconnected tracking objects comprising the tracking model.

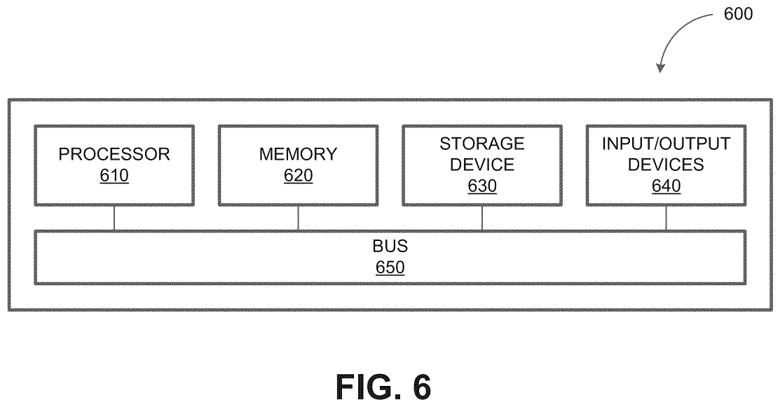

FIG. 6 depicts a block diagram illustrating a computing system 600, in accordance with some example embodiments. Referring to FIGS. 1-6, the computing system 600 can be used to implement the tracking engine 110 and/or any components therein.

As shown in FIG. 6, the computing system 600 can include a processor 610, a memory 620, a storage device 630, and an input/output device 640. The processor 610, the memory 620, the storage device 630, and the input/output device 640 can be interconnected via a system bus 650. The processor 610 is capable of processing instructions for execution within the computing system 600. Such executed instructions can implement one or more components of, for example, the tracking engine 110. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, a hard disk device, an optical disk device, or a tape device, or other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor provides operations comprising:
generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order;
detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event;
determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected tracking objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception associated with the first delivery order impacts the transport event; and
updating, based at least on the impact of the logistic exception, one or more of the plurality of interconnected tracking objects comprising the tracking model.

2. The system of claim 1, wherein the operations further comprise:
in response to determining that the logistic exception impacts the transport event, updating, based at least on the logistic exception, each of the first tracking object corresponding to the order, the second tracking object corresponding to the order item included in the order, the third tracking object corresponding to the delivery order item corresponding to the order item, the fourth tracking object corresponding to the first delivery order including the delivery order item, and the fifth tracking object corresponding to a transport event including the delivery order.

3. The system of claim 1, wherein the transport event is a multistage transport event including a plurality of delivery orders, wherein the determining of the impact of the logistic exception associated with the first delivery order includes determining whether the delay event associated with the first delivery order impacts one or more other delivery orders included in the plurality of delivery orders, and wherein the delay event is propagated to one or more tracking objects representative of the one or more other delivery orders upon determining that the delay event impacts the one or more other delivery orders.

4. The system of claim 1, wherein the operations further comprise:
determining whether the logistic exception associated with the first delivery order impacts a second delivery order included in the transport event, the second delivery order triggering an update event in a location of the delivery order item from the intermediate location to a next location; and
in response to determining that the logistic exception impacts the transport event, updating, based at least on the logistic exception, a sixth tracking object corresponding to the second delivery order.

5. The system of claim 1, wherein the operations further comprise:
in response to determining that the logistic exception associated with the first delivery order impacts the transport event, updating, based at least on the logistic exception, the value of the one or more data fields included in the fifth tracking object representative of the transport event.

6. The system of claim 1, wherein the updating of the one or more of the plurality of interconnected tracking objects includes updating a value of one or more data fields included in each of the one or more interconnected tracking objects.

7. The system of claim 1, wherein the updating of the one or more of the plurality of interconnected tracking objects includes updating a status and/or an estimated arrival time associated with the one or more of the plurality of interconnected tracking objects.

8. The system of claim 1, wherein the operations further comprise:
generating, for display at a client device, a user interface providing a visual indication of the impact of the logistic exception.

9. The system of claim 8, wherein the user interface includes a plurality of interconnected nodes corresponding to the plurality of interconnected tracking objects, and wherein the visual indication includes rendering a first node representative of an impacted tracking object in a first color and a second node representative of a non-impacted tracking object in a second color.

10. The system of claim 9, wherein the visual indication further includes rendering a first directed edge from the first node to the second node in the second color and a second directed edge from the first node to a third node representative of another impacted tracking object in the first color.

11. A computer-implemented method, comprising:
generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order;
detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event;
determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception associated with the first delivery order impacts the transport event; and
updating, based at least on the impact of the logistic exception, one or more of the plurality of interconnected tracking objects comprising the tracking model.

12. The method of claim 11, further comprising:
in response to determining that the logistic exception impacts the transport event, updating, based at least on the logistic exception, each of the first tracking object corresponding to the order, the second tracking object corresponding to the order item included in the order, the third tracking object corresponding to the delivery order item corresponding to the order item, the fourth tracking object corresponding to the first delivery order including the delivery order item, and the fifth tracking object corresponding to a transport event including the delivery order.

13. The method of claim 11, wherein the transport event is a multistage transport event including a plurality of delivery orders, wherein the determining of the impact of the logistic exception associated with the first delivery order includes determining whether the delay event associated with the first delivery order impacts one or more other delivery orders included in the plurality of delivery orders, and wherein the delay event is propagated to one or more tracking objects representative of the one or more other delivery orders upon determining that the delay event impacts the one or more other delivery orders.

14. The method of claim 11, further comprising:
determining whether the logistic exception associated with the first delivery order impacts a second delivery order included in the transport event, the second delivery order triggering an update event in a location of the delivery order item from the intermediate location to a next location; and
in response to determining that the logistic exception impacts the transport event, updating, based at least on the logistic exception, a sixth tracking object corresponding to the second delivery order.

15. The method of claim 11, wherein the updating of the one or more of the plurality of interconnected tracking objects includes updating a value of one or more data fields included in each of the one or more interconnected tracking objects.

16. The method of claim 11, wherein the updating of the one or more of the plurality of interconnected tracking objects includes updating a status and/or an estimated arrival time associated with the one or more of the plurality of interconnected tracking objects.

17. The method of claim 11, further comprising:
generating, for display at a client device, a user interface providing a visual indication of the impact of the logistic exception.

18. The method of claim 17, wherein the user interface includes a plurality of interconnected nodes corresponding to the plurality of interconnected tracking objects, and wherein the visual indication includes rendering a first node representative of an impacted tracking object in a first color and a second node representative of a non-impacted tracking object in a second color.

19. The method of claim 18, wherein the visual indication further includes rendering a first directed edge from the first node to the second node in the second color and a second directed edge from the first node to a third node representative of another impacted tracking object in the first color.

20. A non-transitory computer readable medium storing instructions, which when executed by at least one data processor, result in operations comprising:
generating a tracking model comprising a plurality of interconnected tracking objects that includes a first tracking object corresponding to an order, a second tracking object corresponding to an order item included in the order, a third tracking object corresponding to a delivery order item corresponding to the order item, a fourth tracking object corresponding to a first delivery order including the delivery order item, and a fifth tracking object corresponding to a transport event including the delivery order;
detecting, based at least on an inspection of one or more of the plurality of interconnected tracking objects comprising the tracking model, an occurrence of a logistic exception associated with the first delivery order, the logistic exception being detected based at least on at least one of (i) a delay event associated with the first delivery order and/or the transport event, (ii) a time of an arrival event associated with the first delivery order and/or the transport event, and (iii) a failure to receive the arrival event associated with the first delivery order and/or the transport event;
determining an impact of the logistic exception associated with the first delivery order by at least determining, based at least on the tracking model, whether the logistic exception associated with the first delivery order impacts the transport event, the impact of the logistic exception being determined by at least identifying, based at least on an identifier of the order associated with the first delivery order, the tracking model, traversing the plurality of interconnected objects comprising the tracking model to determine, based at least on an edge interconnecting the fourth tracking object representative of the first delivery order and the fifth tracking object representative of the transport event, that the first delivery order is a part of the transport event, and determining, based at least on a value of one or more data fields included in the fifth tracking object, whether the logistic exception associated with the first delivery order impacts the transport event; and
updating, based at least on the impact of the logistic exception, one or more of the plurality of interconnected tracking objects comprising the tracking model.
